(19) United States
(12) Patent Application Publication
(10) Pub. No.: US 2018/0107800 A1
(43) Pub. Date: Apr. 19, 2018

(54) SECURE DATABASE SYSTEMS AND METHODS FOR DELIVERING HEALTH CARE TREATMENT

(71) Applicants: Kimberlie Cerrone, San Francisco, CA (US); Farid Agahi, San Francisco, CA (US); Dan Altobello, San Francisco, CA (US); Seth Norman, San Francisco, CA (US); Todd Ackerman, San Francisco, CA (US)

(72) Inventors: Kimberlie Cerrone, San Francisco, CA (US); Farid Agahi, San Francisco, CA (US); Dan Altobello, San Francisco, CA (US); Seth Norman, San Francisco, CA (US); Todd Ackerman, San Francisco, CA (US)

(73) Assignee: Tiatros Inc., San Francisco, CA (US)

(21) Appl. No.: 15/784,144

(22) Filed: Oct. 15, 2017

Related U.S. Application Data
(60) Provisional application No. 62/408,748, filed on Oct. 15, 2016.

(51) Int. Cl. G06F 19/00; G06N 5/02

(52) U.S. Cl. CPC G06F 19/3418; G06F 19/328; G06F 19/345; G06F 19/363; G06F 19/325; G06N 5/022; G06F 19/322

(57) ABSTRACT

Databases comprising autonomous or semi-autonomous platforms for the diagnosis and treatment of patient conditions are disclosed. A CarePod is configured to be a system for affecting an authenticatable, HIPAA-compliant communications and monitoring platform to facilitate patient's on-going diagnosis and treatment of a given condition. In the area of psychotherapy, CarePod/IA may affect methods for allowing new members into the treatment group by directing a set of diagnostic tools and tests, ingesting response data, re-evaluating such response data to fine tune diagnosis as to patient's condition. Facilitated communications by and between members may be monitored by and between members by a CarePod/IA and, depending upon threshold conditions, may either update a patient's care dashboard/record or take a plurality of actions (e.g., emergency responses) as the situation dictates.

### CROSS-REFERENCE TO RELATED APPLICATIONS

This Patent Application claims the benefit of, a co-pending provisional application with a Ser. No. 62/408,748 filed by common Inventors of this Application on Oct. 15, 2016. The disclosure made in the application Ser. No. 62/408,748 is hereby incorporated by reference in its entirety.

### BACKGROUND

In many segments of the healthcare industry, there are a number of critical care areas that are underserved by a large and growing patient population with behavioral health problems. For merely some examples, insomnia, trauma, opioid addiction, depression, anxiety and obesity are just such a large and growing area of critical care, brought on by a near epidemic of cases.

Similarly, many employer are seeing that their employees and the employees' family members that they also insure are experiencing behavioral health problems that impact their productivity at work and that lead to higher healthcare utilization rates and costs, For merely some examples, insomnia, trauma, opioid addiction, stress, depression, anxiety, obesity and grief are large and growing area of concern.

One specific critical care area that meets the above description is Post-Traumatic Stress Disorders (PTSD). In America alone, the number of returning veterans who have served in military and in and around combat represent a large and potentially growing patient population.

According to the Department of Veterans Administration (VA), PTSD can occur after someone has been through a trauma—which is not necessarily a rare event. The VA estimates that about 60% of military men and 50% of military women experience at least one trauma in their lives. Women are more likely to experience sexual assault and child sexual abuse. Men are more likely to experience accidents, physical assault, combat, disaster, or to witness death or injury. (See http://www.ptsd.va.gov/public/PTSD-overview/basics/how-common-is-ptsd.asp).

In addition, it is estimated that 7-8% of the general population will have PTSD at some point in their lives. About 8 million adults have PTSD during a given year. About 10 of every 100 women (10%) develop PTSD sometime in their lives compared with about 4 of every 100 men (4%). (See http://www.ptsd.ne.gov/what-is-ptsd.html).

To address these needs, doctors currently create and administer treatment plans for patients for a wide variety of conditions. Oftentimes, patients may not be clear on instructions for attending therapeutic sessions, taking medications or the need for follow-up and informing doctor's regarding changing mental and physical conditions, reactions to the treatment or providing information regarding their medical condition or changes thereto.

In delivering healthcare to such patient populations, it would be desirable to give providers, provider systems, employers, payer systems, governments, and others a portfolio of remote applications that have enough intelligence and power to influence what they consider to be their patients' most fundamental, least addressed determinant of health.

For example, it may be the case that as much as 65% of a patient's health outcome in some critical care areas is determined by social factors, compared to only 10% by the correct diagnosis and treatment of their disease. It would also be desirable to have a system that works alongside a patient's Electronic Medical Record (EMR), safely removing the institutional boundaries, geographical distances, and lack of accessibility that have previously prevented technologies from positively impacting healthcare's most critical factor.

For further example, he World Health Organization estimates that mental illnesses are the leading causes of disability adjusted life years (DALYs) worldwide, accounting for 37% of healthy years lost from NCDs. Depression alone accounts for one third of this disability. The new report estimates the global cost of mental illness at nearly $2.5T (two-thirds in indirect costs) in 2010, with a projected increase to over $6T by 2030. (See https://www.nimh.nih.gov/about/directors/thomas-insel/blog/2015/mental-health-awareness-month-by-the-numbers.shtml). It would also be desirable to give providers, provider systems, employers, payer systems, government agencies, and others a portfolio of remote applications that address patients' and employees' treatable behavioral health problems employing evidence-based treatment methods, providing safe and engaging behavioral health and resiliency programs that improve health and productivity and lower healthcare costs while leveraging scientifically-proven therapeutic methods and the power of peer communities to foster healing and healthier, more successful behaviors.

Such a novel ability to care for patients, employees and family caregivers may help to extend individual health outcomes and create value for every stakeholder in the delivery of healthcare.

### SUMMARY OF THE INVENTION

Several embodiments of the present invention comprise systems and methods of creating, managing and accessing behavioral health therapeutic and resiliency plans for patients having a condition are disclosed herein. Patients, employees, employees' family members, and caregivers have CarePods created for the treatment of their condition and their doctors and other caregiver relevant to their treatment.

In one embodiment, a system architecture for treatment plans may be constructed by a CarePod/IA that may input data and metadata regarding the condition, the diagnosis and treatment options—and how such CarePod/IA may interact and alter data and signals on patient's smart devices that may be in communication with a CarePod/IA. An intelligent agent (IA) may be employed to monitor and ingest data and signals from the communications by and between CarePod members and to autonomously diagnose and affect treatment options depending on the data ingested.

In one embodiment, a system architecture supports the unfettered and untouched capture of the unstructured behavioral health data contained in these psychiatric evaluations, patient narratives, and patient interactions, preserving its clinical richness for the first time. As a result, the solution creates and maintains a novel database that preserves an enormous amount of previously unused and discarded behavioral health clinical data from which natural language analytics can derive clinically-relevant insights to enable data-driven clinical decisions that inform better patient outcomes and advance population health.

Other features and advantages of the present system are presented below in the Detailed Description when read in connection with the drawings presented within this application.

### BRIEF DESCRIPTION OF THE DRAWINGS

FIG. 1 shows a high level block diagram of a system providing a full range of autonomous/semi-autonomous treatment to a set of trusted users in a social care setting.

FIGS. 2A through 2C depict several embodiments of methods and systems of CarePod/IA interactions with CarePod members and/or patients in a diagnostic/therapeutic setting.

FIG. 3 depicts several embodiments of how a CarePod/IA may monitor ingested data from participants and patients and determine when to raise an alert as to a possible critical change in patient status.

FIG. 4 depicts several embodiments of CarePod/IA response to potential critical change in patient status to meet the circumstances during interactions.

FIG. 5 depicts several embodiments of how a CarePod/IA may interact with analytic engines/services that may be employed in the treatment of patients.

FIG. 6 shows an embodiment of how a CarePod/IA may facilitate various communications and interactions with members of a peer group that may represent a condition support group.

### DETAILED DESCRIPTION

Overview

Although the following description may be couched primarily in the language of treating PTSD conditions in a social group of patients, it should be appreciated that the present specification encompasses the treatment of any medical/mental/physical conditions for which social interactions may be helped by the systems and methods of the present application. For merely some examples, obesity, diabetes, eating disorders, anxiety, cancer, other diseases, drug and/or alcohol dependency, victims of sexual, physical and/or mental assault, etc. are also possible areas of critical care for which the present systems and/or methods may find applicability.

In many embodiments, platform architecture are disclosed that support the unfettered and untouched capture of the unstructured behavioral health data contained in psychiatric evaluations, patient narratives, and patient interactions, preserving its clinical richness for the first time. As a result, a novel database is created and maintained of unstructured behavioral data that preserves an enormous amount of previously unused and discarded behavioral health clinical data from which natural language analytics can derive clinically-relevant insights to enable data-driven clinical decisions that inform better patient outcomes and advance population health. The solution employs cognitive computing and Al technologies to develop program enhancements that will ultimately give doctors useful, real-time clinical insights that inform better treatments as well as improve population health.

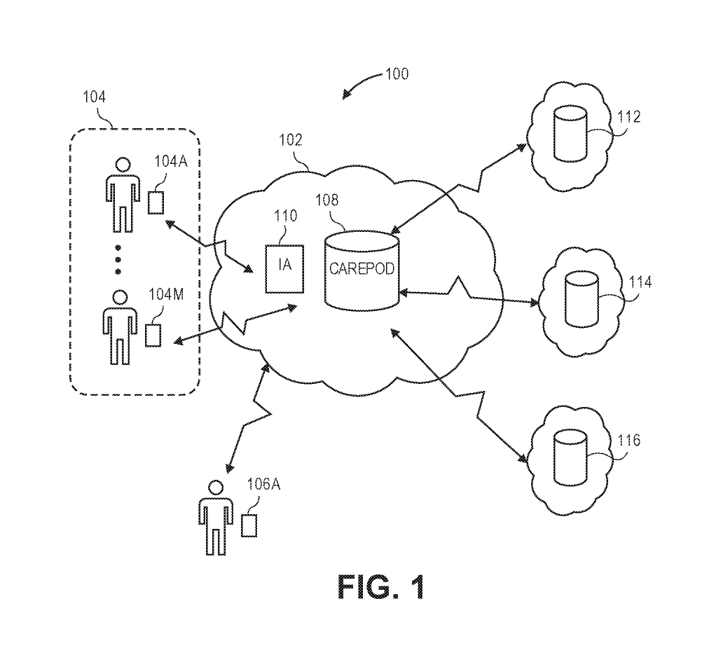

FIG. 1 depicts a high level diagram of one system-level embodiment of the present application and a potential environmental setting (100). Environment 100 shows that a group (104) of one or more patients (104a, . . . , 104m) is in communication with a CarePod system 108. CarePod system 108 may be on site, or it may be remote, and residing on a server on a network 102 (e.g., the Internet or some other network, local or global). Patients 104a, 104m may be seen communicating with system 108 in either a real-time, near real-time, synchronous, asynchronous basis with each other, system 108 and/or a care provider 106a (or multiple providers).

Any suitable care provider 106a may include (but not necessarily limited to): a moderator for group discussions, a psychiatrist, a physician and/or family members—i.e., any persons that may be trusted care givers/providers and have been given access (to whatever level of interactions set by the system) in a CarePod set up for such a group of patients.

Such CarePod systems have been previously described in co-owned United States Published Patent Applications as:

(1) United States Patent Application 20120277543, to Homchowdhury, published on Nov. 1, 2012, entitled “SYSTEM AND METHOD FOR UPLOADING AND SECURING HEALTH CARE DATA FROM PATIENTS AND MEDICAL DEVICES TO TRUSTED HEALTH-USER COMMUNITIES”;

(2) United States Patent Application 20120278095, to Homchowdhury, published on Nov. 1, 2012, entitled “SYSTEM AND METHOD FOR CREATING AND MANAGING THERAPEUTIC TREATMENT PROTOCOLS WITHIN TRUSTED HEALTH-USER COMMUNITIES”;

(3) United States Patent Application 20120278101, to Homchowdhury, published on Nov. 1, 2012, entitled “SYSTEM AND METHOD FOR CREATING TRUSTED USER COMMUNITIES AND MANAGING AUTHENTICATED SECURE COMMUNICATIONS WITHIN SAME”; and

(4) United States Patent Application 20120278103, to Homchowdhury, published on Nov. 1, 2012, entitled “SYSTEM AND METHOD FOR UPLOADING AND SECURING HEALTH CARE RECORDS TO TRUSTED HEALTH-USER COMMUNITIES”—all of which are hereby incorporated by reference in their entirety.

Each patient may have an electronic device to conduct such communications. Any suitable electronic device may be possible, including (but not necessarily limited to): a cell phone, smart device, tablet, laptop, desktop, etc. Patient's communications may assume the full panoply of possible communications by and between members of the CarePod at one time or another (e.g., for one session or over an extended period of time)—for example, email, SMS, text or other asynchronous communication means and/or phone, video, video calling or other synchronous communications means.

A patient's smart device will have an executable application (App) that, at various times, interacts with the CarePod system. This application has partial responsibility in the authentication of the member, the security (and HIPAA compliance) of the communications and the upload and/or download of data and/or instructions to CarePod 108. For example, CarePod 108 may upload data from the patient (e.g., answers to queries made to the patient from CarePod 108, physiological status data of the patient and many others examples).

In addition, CarePod 108 may download data and/or instructions to the smart device. For example, CarePod 108 may download questionnaires to the patient—for the patient to answer in any suitable medium. Based upon data ascertained during a communications sessions, CarePod 108 may (either autonomously, by direction of a caregiver, or otherwise) determine a change in patient status and download instructions to the patient—or take other actions as deemed necessary to ensure the safety of the patient (as will be discussed in greater detail below).

Intelligent Agents

In many embodiments, one (or more) Intelligent Agent(s) (IA) 110 may reside somewhere where electronic communications are possible (e.g., in CarePod system 108, on patient's electronic devices, or elsewhere)—e.g. in communications with one, some, and/or all of the above-mentioned entities. In the present context, an IA is an agent with some degree of artificial intelligence and/or abilities that helps/assists/enables the communication and/or treatment of the patients at issue.

As will be discussed further below, such IA(s) may be actively and/or passively engaging in the communication by, and/or, between patients and care providers or any other authorized entities in the CarePod. In a passive role, IA(s) may be “listening” to the conversations taking place between all authorized entities, making possible diagnosis, making reports (e.g., back to care providers), providing alerts (e.g., in the case of a certain assessed possibility of harm to one or more patients) and the like. In a more active role, IA(s) may be asking patients (or other CarePod members) for their status (e.g., mental, physical, social, etc.) and recording such interactions and reporting/alerting results as deemed appropriate.

In the art, intelligent agents have been described in many applications, including:

(1) United States Patent Application 20150039317, to Klein, published on Feb. 5, 2015, and entitled “SYSTEM WITH MULTIPLE SIMULTANEOUS SPEECH RECOGNIZERS”;

(2) United States Patent Application 20100185566, to Schott, published on Jul. 22, 2010, entitled “APPARATUS AND METHOD FOR PROBLEM SOLVING USING INTELLIGENT AGENTS”; and

(3) United States Patent Application 20030084010, to Bigus, published on May 1, 2003, entitled “DISTRIBUTION MANAGEMENT OF INTELLIGENT AGENTS USING DISTRIBUTION CONTROL INFORMATION”—all of which are hereby incorporated by reference.

In addition to the optional IA that may be running during operation of CarePod system 108, IA 110 and/or CarePod 108 may be in communication with one or several analytic database(s) (e.g., 112, 114, and/or 116). For example, database 112 may be natural language analytic database and/or service that may be ingesting the natural language communications of the CarePod members to assess the state of patients, changes to those states. This may be based on written and/or typed communications from text messages by the patients—or answers to queries that may be generated and downloaded to the patients from CarePod 108 and/or IA 110. These IAs may be instantiating and/or assigned to communicate with the patient and the patient's CarePod through appropriate Application Programming Interfaces (API). Such APIs may be appropriate depending on the architecture of the database system and the method of deploying remote communications and rendering services.

Another database 114 may be employed as a visual analytic database/service that may be operating and/or in communications with camera units associated with patient's smart devices, etc. CarePod 108 and/or IA 110 may be ingesting image data of the patient—e.g., detecting subtle clues as to the patient's state during a time of active interaction that the patient is having with the CarePod. For merely one example, image data ingested at the time that CarePod, IA, physician, and/or other members may be analyzed for nuanced facial reactions—e.g., perhaps in response to directed questions or utterances that may be known in the art to evoke a reaction that may be signs of an underlying state and/or condition.

Another database 116 may be employed as an aural analytic database/service that may be operating and/or in communication with phone or other microphone pickup associated with patient's smart device. CarePod 108 and/or IA 110 may be ingesting audio data of the patient—e.g., detecting stress conditions in utterances of a patient, perhaps in response to specific communications, data and/or signals given to the patient by CarePod, IA, physicians and/or other members.

It will be appreciated that all of these aforementioned databases/services may be implemented as one or many such databases/services and that they may reside and execute at many potential points in the environment—e.g., at CarePod, IA, on smart devices—wherever it is known in the art to implement. The patient's smart device may record such other digital data (e.g., visual, aural, other physiological data) during the time of the testing with the various protocols. This other digital data may be correlated against the responses to the testing protocols and checked for any consistencies and/or inconsistencies with initial diagnosis of the patient.

### One Psychotherapeutic Embodiment

As mentioned above, the systems and/or methods of the present application may be applicable in the context of many diseases or treatment conditions—and that psychotherapy for mental conditions (such as PTSD) are merely one example of the application of the present application. With that said, the following is descriptive of one and/or many embodiments in this domain.

### I. Product and Role Type Definitions

Product Description

Cognitive Behavioral Therapy (CBT), Mindfulness Based Cognitive Behavioral Therapy (MB-CBT), Narrative Therapy. Psychoeducation, psychotherapy, group psychotherapy, and therapy are each appropriate terms for the present discussion. In one embodiment, a CarePod delivers effective, evidence based psychotherapeutic interventions.

Possible CarePod Roles

In the course of treatment, a CarePod may—either autonomously (e.g., possibly in concert with IA direction) or semi-autonomously under direction of a physician or others—assume a plurality of roles. For merely several examples, a few are given below:

Instructor: as the person who appears in the psychotherapy videos. Instructor may be teaching the theory and practice of psychotherapy and demonstrating the cognitive exercises, as well as modeling good storytelling for the patient.

Science Instructor: as the person who appears in the neurobiology focused portions in the psychotherapy videos and also teaches the behavioral exercises.

Facilitator/Moderator: as the person responsible for facilitating online discussions, giving feedback on narrative assignments and monitoring participation. This may be an active role, and Facilitator/Moderators will ensure course completion and proper course conduct with as little intervention as necessary.

Senior Moderator (or Senior Engagement Officer): as the person responsible for supervising the conduct and performance of Facilitator/Moderators. They may not be directly responsible for the completion and conduct of a specific course of therapy; instead they are responsible for several Facilitator/Moderators.

Staff Clinician: as the person responsible for reviewing health reports, managing Patient crises, diagnosis, and even prescriptions.

Customer Roles

As for humans that may interface/employ a CarePod, there are potentially a number of roles that these people may assume as follows:

Patient: A person enrolled in a course of group psychotherapy that has received a diagnosis prior to beginning treatment, and is prescribed CarePod, by his physician or licensed psychotherapist.

Co-Patient: This is how a Patient will see the other Patients in their group identified. The use of Co-Patient underscores that this person is not a separate entity seeking treatment; the entire group's treatment requires teamwork.

Participant/Co-Participant: A person enrolled in a course of group psychotherapy who has not received a diagnosis prior to beginning. This is someone who found his way to CarePod on his own and signed up for a CarePod group experience. He may later be diagnosed by a doctor and converted into a Patient. However, it is important to distinguish the Participant role type from a clinical categorization. (May instead refer to them, as members, guests, students, clients or fellows).

Physician: A clinician with the ability to add Patients to CarePod. They will receive reports and billing statements related to the Patients they add.

Supporter: A person added to the Patient's account by the Patient or Physician. This person is typically a loved one or family member, and has the ability to watch the videos, view course educational materials, read the Patient's submissions, and comment on them. They cannot see anything submitted by other Patients or participants, and cannot create their own submissions. They are subject to conduct oversight by the Moderator.

### II. Pre-Treatment Process

The following are possible ways of interacting with a CarePod as a manner of pre-treating possible patients:

Step 1: Diagnosis

A diagnosis is not necessary to begin participation in a group. However, this type of customer will be identified as a Participant.

Initially, most Patients directed to CarePod will have been first diagnosed by a mental health professional, and then invited onto CarePod via their Physician account. In the future, we may want to allow the Physician to invite the Patient into CarePod in order to conduct the diagnostic process using our digital form. In the future, they may want to invite the Patient into CarePod and allow a Watson-powered avatar to lead the diagnostic process.

CarePod can support the making of a diagnosis by allowing the digital delivery of these diagnostic tools. For merely some example (and not meant to comprise a comprehensive list), the following are possible for pre-treatment:

Structured Clinical Interview for DSM-5: The SCID-5 is the most widely used comprehensive structured diagnostic instrument for assessing mental illness. It is always delivered by a specially trained clinician and typically takes several hours to complete.

Post-traumatic Stress Disorder Check List—Military: The PCL-5 is the standard psychometric evaluation for patients reporting symptoms from their military experience. It is used to both diagnose the disease and monitor progress during treatment. It consists of 20 questions related to the patient's behaviors and feelings in the past 30 days, and is answered on a scale of Not at All (0 Points) to Extremely Bothered (4 Points). The Veteran's Administration recognizes a score of 33 or above as a reasonable score for diagnosing PTSD, though there is room for interpretation by the clinician. The VA also believes a 5-point improvement in the patient's score is the minimum viable threshold for determining a clinically meaningful response, and a score change of more than 10 points is considered a significant response.

Step 2: Invitation Into CarePod

For a participant finding his own way to CarePod, e.g., referred by a friend, perhaps a button to request an invitation would be helpful. It could include a demographic survey and a brief narrative about why he/she wishes to participate. Completing the narrative will screen for those serious about the intervention. The demographic survey will allow CarePod to vet participants and screen out potential predators.

Step 3: Taking the Self-Assessment and Setting Goals

Broadly, this sets the active, motivated tone for the treatment by helping Patients become familiar with the product's interface, helping them realize serious, medical grade nature of this treatment, and getting them used to participation right away.

The completion of a personality self-assessment is the first attempt at making the Patient comfortable working in a mindset of personal reflection. This also reminds him that his peers will be putting the same effort into this process and are deserving of his full effort and attention. The first part of this self-assessment will be in the form of writing an introductory personal narrative describing his life, its challenges, his values and goals and his reasons for wanting this intervention. This narrative will be analyzed automatically by Personality Insights, giving the Patient an opportunity to develop some self-awareness about how he navigates life.

The setting of specific, timely goals is critical to the proper completion of group interventions. Not only do they provide measureable reference points from which to identify improvement, they allow other members of the group to hold the Patient/participant accountable to the treatment. This is the first step in developing healthy group dynamic and building personal bonds between participants.

The following is a possible set of questions that may be used for this step:

1) Describe the problems that led to you signing up. These can be general problems you've experience for years, or a specific issue from last week that made you decide it was time to get help. (300 Words)

2) Imagine that when you go to bed tonight, all of your problems will be solved. When you wake up in the morning, how will you know things are better? What specific changes do you notice in your life? (300 Words)

3) Now that you've imagined your better life, we have to turn that imagination into practical goals. What are three broad, personal goals you'd like to work on during this intervention? A good example would be: “I want to have a better relationship with my spouse.” Think about these goals carefully because we'll share them with the other participants so they can help you stay accountable. (50 Words Each)

It should be noted that it may be desirable to enforce a maximum word limit for this question (and possibly others). A word limit forces the Patient to focus on describing their goal succinctly. This is important for learning to describe what he wants directly and also makes the goal descriptions short enough to appear on the Patient's profile.

4) For each of the three goals listed above, describe specifically how you'll know life is better when they're achieved. A good example would be: “My spouse and I would communicate better about our problems and be able to get through disagreements without getting into big fights.” (100 Words Each)

5) A value is a belief that informs decision making. For example, if I value environmental protection, I may purchase recycled paper for my printer. Tell us 5-10 values that inform you. (50 words each)

6) Success in groups requires focus and attention, because the best learning happens when you're really engaging with your thoughts and feelings. To get this serious work done, you need to have a safe, comfortable place to work from. Tell us a little bit about where you'll be participating. What makes this a safe, comfortable space for you? (100 Words)

7) Tell us what you think you bring to a team. Your answer will be private, and this isn't a job interview, so your answer can be good or bad, broad or specific, personal or technical. Just tell us what kind of teammate you think you are. (100 Words)

8) What's something you would absolutely demand from your teammates in order to make group participation safe and helpful? (100 Words)

9) How will the group know when something has gone wrong for you? Do you typically stop talking when you've been offended? Do you get impatient when you feel misunderstood? Tell us a few things to be aware of so we can help make this a more positive healing experience for you. (100 Words)

10) Tell us where you think you fall on the following spectrums:

It should be noted that there may be no real score for this question. In fact, using the sliding scale instead of a number scale may be intentional so as to avoid implying that one side of the spectrum was somehow more valuable. It may be desirable to want the patient to think about themselves as a teammate. Later, they'll be able to compare their assessment to Watson's, and this creates an opportunity for self-awareness prior to beginning the intervention. Notice that the 5 categories match the Big 5 Personality Traits.

11) This is your chance to write down anything else you think is important for us to know. We won't share it with the group, so let us empower you to tell us anything that might increase your chances of success. (No minimum or maximum number of Words)

Step 4: Delivery of 1st Analytic Feedback

The completion of the introductory narrative and the teamwork self-assessment along with the setting of goals provides the first opportunity to feed Personality Insights API some unstructured data. All points of the analysis may be of interest to the patient. For example, the Big 5 Personality Traits, are inherently digestible and, and the values and needs indexes are easily relatable.

This feedback on all desired points may be shown in the Patient's profile.

Step 5: Creation of the Profile

A final patient profile may be available to view by every other CarePod user. Patients will be encouraged to use real pictures and information, but will have the ability to use any name and avatar image they choose in order to remain more anonymous. However, names and profile pictures may not be left blank, because this practice creates resistance to openness and sharing from other Patients.

The following components will be included in the Patient's profile:

Profile Picture: Patients are invited to use a real picture, or to pick an avatar that approximates their appearance. They must choose an image before entering the group, because the first step in establishing trust and connection is a sense of knowing who you're working with. It is important that patients are not able to leave a blank or generic profile picture because it signals a lack of engagement to their Co-Patients.

List of 3 General Goals: These are taken from the self-assessment and goal setting questionnaire.

Big 5 Personality Trait Scores with Brief Explanations: The scores should be reported in a bi-polar presentation, so that no judgments can be drawn from the presentation about one being better than the other.

These scores are taken directly from the CarePod-powered assessment, and can be presented like this:

### III. Digital Psychotherapeutic Intervention Template

Typically, an established content structure improves completion rates because it creates a sense of comfort and routine. Every section in this template should remain, regardless of the specific treatment, and they are designed to be flexible.

In one example, a new session's materials become available at 6 AM (PST) on Monday. Patient's must complete and submit the session's requirements by 6 AM (PST) on Thursday. Patients must comment on their Co-Patient's submissions by 6 PM (PST) on Friday. The timing of this workflow is meant to simulate the rhythm of in-person group therapies, while also giving Patients enough time to complete their work. A Monday-Friday schedule also mirrors the working hours of a psychotherapist, reminds the Patient that this treatment should be treated like a serious job, and eases the workload for CarePod Moderators.

The classes are organized so that an average Patient can move from starting the first lecture video to submitting the last written assignment in 1 hour. The 20 minutes allotted for journaling and the estimated 10 minutes for commenting bring the total weekly workload to 1.5 hours, which is the broadly accepted threshold for a weekly in-person group psychotherapy session.

Step 1: Bridge

This is a 2-3 minute scripted video from the Instructor.

This lecture touches on the content from last week's session in order to refresh key points and make the connection between its content and the content to be delivered in this session.

Step 2: Agenda

This is a 2-3 minute scripted video from the Instructor.

In addition to introducing the topics of discussion for this specific session, this lecture reminds Patients of the overall structure of the session, the session's place within the overall psychotherapeutic intervention, and reminds Patients of session norms.

It is possible to think of the bridge and agenda sections as being two halves of the same step, but they should be separated into two video segments for ease of interchangeability during the course building process. Also, at the end of each video segment, Patients may be prompted to move on to the next section or to watch the section over again; having the bridge section stand on its own makes it easier to review last week's highlights more quickly.

Interactivity is possibly desirable to engaging and sustaining patient/participant engagement. Thus each video will instruct patient/participants to write a narrative, practice meditation, complete a form, submit a discussion prompt, or interview another patient/participant.

Step 3: Status Report

This is a digital submission completed by the Patient.

Patients can take as long as they want to complete the form, but it is designed to be completed in 3-5 minutes and should be submitted before moving on. The purpose of this step is to notify the Patient that the session is moving from the review section of the session into new material, to ensure the Patient is aware that his full attention and focus are necessary, to make the Patient aware of his current feelings and remind him that he is about to carry those feelings into a group setting, and to prime the flow to written participation from the Patient. This step also helps sustain engagement

The content from these questions can also be fed to CarePod for analysis, and may be particularly useful in the development of behavior prediction tools.

Questions to be asked:

1) Are you in your usual working space right now? Are you feeling focused? Do you feel safe? Just tell us where you are and if you're feeling focused today. There's not wrong answer here. (100 Words)

2) Choose 3 of the emotions on this list that best express how you've felt since you last checked in. (List of emotions available here).

3) Tell us what you think has led to your feeling these 5 emotions. The answer can relate to something in your current personal life, past experience, something at work, or from participating in this intervention. (100 Words)

4) Do you feel ready to work this week? Is there something we could know that would make your participation easier or deeper? No wrong answer. (100 Words)

5) Do you have anything else you'd like to share? We won't show it to the group, so feel free to share anything. (0 Words)

Step 4: Structured Reflection

This is a 10-12 minute scripted video from the Instructor.

In this section, the corresponding Hero's Journey step is discussed. A personal story is shared, as is a story from either a played movie clip or read book passage.

Step 5: Cognitive Exercise

This is a digital submission completed by the Patient.

At the top of this section will be a 1-2 minute instructional video about the exercise lead by the Instructor. The Patient can replay the video if they need a refresher while completing the written fields.

This exercise relates to what was discussed in the Structured Reflection section.

Patients can take as long as they want to complete the form, but it is designed to be completed in 10-12 minutes and they must meet the minimum word count in order to submit and move on.

Step 6: Psychoeducation

This is a 10-12 minute scripted video from the Science Instructor.

This lecture focuses on the brain's reaction to trauma. The goal of this portion is to promote understanding, normalize experience, and help understand that reactions can be controlled and brains can heal.

Step 7: Behavioral Exercise

This is a digital submission completed by the Patient.

At the top of this section will be a 1-2 minute instructional video about the exercise lead by the Science Instructor. The Patient can replay the video if they need a refresher while completing the written fields.

This exercise relates to what was discussed in the Psychoeducation section. Patients can take as long as they want to complete the form, but it is designed to be completed in 10-12 minutes and they must meet the minimum word count in order to submit and move on.

Step 8: Salutogenesis Journal

This is a digital section completed by the Patient in an ongoing nature.

Salutogenesis describes an approach focus on the factors that support human healing, health, personal growth and well-being, rather than on factors that cause disease.

Though there is no specific prompt for this weekly journal, patients are encouraged to talk about whatever they want while incorporating descriptions of feelings and how reaching their therapeutic goals could impact those feelings. They may be prompted to think about discussing how they would incorporate this week's learnings with their therapeutic goals.

Patients must have their journal window open for a total of 20 minutes each week to complete the assignment, though they may go longer. There is no minimum word count for this portion of their work, because there is value in even just quiet reflection.

Step 9: Commenting

Responses from each week's Cognitive and Behavioral Exercises may be shown to the group. Patients must comment on at least 2 posts each week, with a minimum of at least 100 Words per comment. CarePod will ensure that each patient receives at least 1 comment per week. Patients are encouraged to be positive, and to connect the patient's experiences to their own.

Step 10: Assessments

Progress in psychotherapy must be measured. A monthly delivery of the PCL-M, or of future CarePod-enabled assessments can be included at this point, though not necessarily every week.

### IV. PTSD for Veterans Psychotherapy Syllabus

In this embodiment, the content of this course follows the template described herein, so it unnecessary to list the topics of discussion in the bridge and agenda sections. The status report tool described in section IV is also the same in every course and class, as are the requirements for the salutogenisis journal, commenting, and assessments. Therefore, we will only break down the content of the remaining section, which have a variation in topic, but not structure.

Session 1: You are the Hero of Your Journey

It should be noted that the first class may be the only one not to have a bridge section. In its place, there may be a short introduction to the course and the Instructors, as well as background statistics on PTSD. This could be considered a bridge from life before CarePod to the world of CarePod psychotherapeutics).

Structured Reflection:

Description of Hero's Journey Step 1: Ordinary World.

Lecture on how to talk about ourselves, and specifically who we were before our trauma (in this case, before we joined the military), and how to build the foundation of our personal growth.

A personal example from the Instructor and a contemporary video example.

Cognitive Exercise:

Lecture on the importance of examining yourself so you can talk about who you are, followed by practice in the form of introducing yourself to the group.

Questions for this exercise:

1) Tell us a little bit about the early you. Where did you grow up? What was life like then? What are your favorite memories to share from that time? (50 Words)

2) Tell us about your family. You can define family however you want. Are they the people you're related to, someone you're dating, or friends? (50 Words)

3) Tell us what made you decide to join this group. Focus on the specific moments and events that made you decide it was time to seek support. (150 Words)

4) Tell us what you hope to get out of this psychotherapeutic intervention. You goals are listed on your personal profile, so you can either expand upon them here, or discuss deeper motivations here. (150 Words)

5) Tell us a little bit about your military experience. Don't worry about going too deeply into the details, because we're going to have plenty of time to talk about everything. For now, just give us the highlights and broad strokes. (100 Words)

Psychoeducation:

Introduction to the importance of psychoeducation as a component of psychotherapeutics.

A reading of Brain Facts (Pages 4-5) to serve as an introduction to the power of the brain to influence our sense of self and our bodies.

Behavioral Exercise:

Note on the importance of developing body awareness in order to be aware and in control of feelings and emotions.

Video exercise where the Science Leader takes the Patient through a 10-step body awareness exercise.

Questions for this exercise:

1) Jot down a few notes about your experience, keeping the langue of the bodily sensations: tension, temperature, breathing, etc.; for example, When I was sitting in my chair, I felt tense in my shoulders and my feet were warm. When I moved to stand on the floor, mu feet became cold and my shoulders relaxed. (100 Words)

2) After doing this exercise, are you more aware of your body? Whether you answer yes or no, tell us why you think that is. (100 Words)

Session 2: The Needs that Call Us

Structured Reflection:

Description of Hero's Journey Step 2: Call to Adventure.

Lecture on why it's important to understand what drives all human beings, and what drives us specifically.

A personal example from the Instructor and a contemporary video example.

A reading of On the Rainy River (Pages 41-49) to serve as inspiration for understanding and telling the story of your call.

Cognitive Exercise:

Questions for this exercise:

1) Tell us what called you to join the military. What factors went into your decision? What were your concerns? (150 Words)

2) When you left for the military, you knew it was going to be a life changing experience. What sorts of changes to who you were did you hope to see? (150 Words)

3) Tell us what called you to seek help. Can you pinpoint a specific moment that caused you to agree to treatment? Be as specific and open as you feel you can be. (150 Words)

4) Coming to therapy is a sign of strength and hopefulness. Tell us how you hope to change by completing your treatment. Imagine the future you. What kind of person do you see? (150 Words)

Psychoeducation:

Introduction to learning, memory and language.

A reading of Brain Facts serves as an introduction of how our sense of memory controls our emotions and outlooks.

Behavioral Exercise:

Note on the importance of working on organizing memories, even if they're negative.

Video exercise where the Science Leader takes the Patient through the Escaping the Bog of War visualization exercise.

Questions for this exercise:

1) Now that you've completed your bog drawing, please upload a picture of it. Tell us what we're looking at in your own words. (100 Words)

2) Imagine yourself in your bog again. What's your mission in this bog? Is it to get out? Are you waiting for the right moment to start moving? Do you plan to stay in the bog? Why do you think your imagined mission in the bog might say about you now? (150 Words)

3) Whatever you decided your mission to be, now imagine that you've gotten out of the bog and you're standing on the other side of it. What does it look like there? How does it feel to be out of the bog? Was there anything waiting for you on the other side? (150 Words)

Session 3: The Meaning of Our Mentors

Structured Reflection:

Description of Hero's Journey Step 3: Meeting the Mentor.

Lecture on how we look up to the people who embody who we want to be and why it's important to think carefully about who those people are.

A personal example from the Instructor and a contemporary video example.

A reading of The White Donkey to serve as inspiration for understanding who we want to be like.

Cognitive Exercise:

Questions for this exercise:

1) Write a letter to your Drill Sergeant. Tell him how you were influenced by basic training. Tell him which of the lessons you learned there are still important to you. Tell him which ones you think are wrong now. (200 Words)

2) Tell us about a time you guided someone on their journey? After you write about the specifics, imagine you guiding that person again. How does it make you feel to help someone? (200 Words)

3) Make a list of at least 10 things you're really good at. It doesn't matter if you put rocket science or chewing bubble gum on your list. Just tell us what you'd enjoy bragging about. (100 Words)

Psychoeducation:

Introduction to cooperation and why the human species was meant to work together.

A dissection of a contemporary video example.

Behavioral Exercise:

Learning to change our core beliefs about intimate relationships.

Questions for this exercise:

1) Identifying your beliefs about intimate relationships:

A) Complete this phrase: To me, an intimate relationship means I . . . (20-100 Words)

B) At this moment in time, are you in an intimate relationship with anyone? What are they like? And if not, describe the type of person you'd like to have an intimate relationship with. (20-100 Words)

C) Define the word “love.” (20-100 Words)

D) List the people you can safely express love safely. If there aren't any, describe what someone you could express love with would be like. (20-100 Words)

E) From whom and where do you get support? (20-100 Words)

F) How do you express love and support? (20-100 Words)

G) Do you feel more or less distant from others now? If so, to whom? (20-100 Words)

H) Check off the following statements you think describe you:

I stay away from people, I avoid certain social activities, I want to spend my time alone, I am afraid to talk to others, I am afraid to be physically close to another person, and other questions taken from the core beliefs exercise.

2) Identifying your core beliefs about intimate relationships:

A) Choose one of the answers from the previous exercise and ask yourself the following questions: What does that belief say about me? (100 Words)

B) Look at what you just wrote. What does that statement say about you as a person? (100 Words)

C) And now, one last time, what does that last statement say about you as a person? (100 Words)

(Note: The last response gives you your core belief about intimate relationships—the deep belief that underlies the others).

3) Challenging your core beliefs about intimate relationships:

A) Does this belief fit with my priorities and goals? (20-100 Words)

B) Does this belief fit with my values and judgments? (20-100 Words)

C) Does this belief make me feel better or worse about myself? (20-100 Words)

D) Does this belief put appropriate demands on me? (20-100 Words)

E) If the answers to these questions is “no,” is there a new belief you'd like to start believing? If the answers we're “yes,” how will you continue to reinforce that belief? (50-200 Words)

Session 4: The Road is Hard, but the Journey is Worthwhile

Structured Reflection:

Description of Hero's Journey Step 4: The Road of Trials.

Lecture on how difficulties and challenges bring pain, and how pain brings growth; if we allow it to.

A personal example from the Instructor and a contemporary video example.

A reading of The White Donkey to serve as inspiration for deciding to choose growth.

Cognitive Exercise:

Questions for this exercise:

1) Tell us about a stressful situation you were later thankful for. (200 Words)

2) Look at this list of personal rights from the emotional boundaries list. Which ones would you select for your own declaration of personal rights? (200 Words)

3) Imagining yourself as someone who has internalized their declaration of personal rights, tell us a part of your life that is now less stressful. (150-300 Words)

Psychoeducation:

Introduction to the effects of stress on the brain.

Listening to the Radio Lab podcast on stress.

Behavioral Exercise:

Video exercise where the Science Leader takes the Patient through a 4-step controlled breathing exercise.

Implementation of the relaxing scene technique while practicing controlled breathing.

Questions for this exercise:

1) When and where did your scene occur? (20 -100 Words)

2) What did you see in this scene? (20-100 Words)

3) What did you hear in this scene? (20-100 Words)

4) What did you touch or feel? (20-100 Words)

5) What did you smell or taste? (20100 Words)

6) What did you feel? (20-100 Words)

7) What else would you add to this scene? (20-100 Words)

8) Can you think of a positive trigger word or phrase to instantly return to this scene when you need it? (1-20 Word)

Session 5: Our Own Best Enemies

Structured Reflection:

Description of Hero's Journey Step 5: Tricksters and False Guides.

Lecture on how we need to be mindful of who we spend our time with and what we spend our time doing.

A personal example from the Instructor and a contemporary video example.

A reading of In the Field to serve as inspiration for deciding to choose growth.

Cognitive Exercise:

Questions for this exercise:

1) Tell us about a time when someone influenced you to do the “right thing,” and it later turned out to be the “wrong thing.” (150 Words)

2) Tell us about some of the ways you engaged in self-harm after your traumatic event. Small or large, we can all come up with examples when we take a moment to think about it. Sometimes the answer is dramatic, like drunk driving or promiscuous behavior. Sometimes the answer is subtle, like being constantly late for work. (150 Words)

3) Write a letter to your child, or a younger version of yourself if you don't have children. Tell them about a time you engaged in maladaptive behaviors, and what you wished you had done with that time instead. Advise them on how they could learn from your mistakes. (200 Words)

Psychoeducation:

Introduction to addiction and how the adrenaline of combat can set us up for maladaptive behaviors.

Listening to the Radio Lab podcast on stress.

Behavioral Exercise:

Learning to change our core beliefs about self-defeating behaviors.

Questions for this exercise are the same as the changing core beliefs about intimate relationships in session 3.

Session 6: The Problem with Blame

Structured Reflection:

Description of Hero's Journey Step 6: The Abyss.

Lecture on understanding the common types of guilt and how they affect our future decisions.

A personal example from the Instructor and a contemporary video example.

A reading of The Field Trip to serve as inspiration for deciding to let go of guilt.

Cognitive Exercise:

Questions for this exercise:

1) Tell us about a time you experienced guilt. (100 Words)

2) Which of the types of guilt described in this session do you think this personal experience falls under? Do you think this is one of the harder types of guilt to deal with, or one of the easier ones? (150 Words)

3) Tell us how you wish you had handled this experience differently. Once you finish, tell us if you think it was realistic to believe you could have done much else than what you actually did. (150 Words)

Psychoeducation:

Introduction to mirror neurons and the evolution of guilt, empathy, and human emotion.

A dissection of a contemporary video example.

Behavioral Exercise:

Learning to change our core beliefs about self-blame.

Questions for this exercise are the same as the changing core beliefs about intimate relationships in session 3.

Session 7: If You Want to Go Fast, Go Alone; If You Want to Go Far, Go Together

Structured Reflection:

Description of Hero's Journey Step 7: The Return.

Lecture on the importance of realizing life is a series of journeys and how we can weave them into our future.

A personal example from the Instructor and a contemporary video example.

A reading of How to Tell a True War Story to serve as inspiration for taking the lead on good communication.

Cognitive Exercise:

Questions for this exercise:

1) In what ways was your return home after your separation from the military similar to how you had imagined it? In what ways was it different? How did it feel to be home? What did you bring home with you and what did you leave behind? (200 Words)

2) Now it's time for some empathy work. Imagine you're your one of your family members; pick the person who's closest to you. Now write a journal entry describing your activities, preparations, and feelings just a few days before your loved one (you) returns home from war. (200 Words)

3) Tell us a story about a misunderstanding with your loved one that seemed serious at the time and now makes you laugh when you think about it. (100 Words)

4) Tell us what you miss the most about combat service. Is there a (healthy and reasonable) way to reintroduce some of those things into your civilian life? (150 Words)

Psychoeducation:

Introduction to the social basis of reintegration and the neurobiology of social affiliations.

A reading of Why Would Anyone Miss War? from the New York Times.

Behavioral Exercise:

Implementation of the communication techniques listed in the workbook (similar to changing beliefs format).

Session 8: Finishing Strong is Only the Beginning

Structured Reflection:

Description of Hero's Journey Step 8: Resurrection.

Lecture on the importance of consolidating what we have learned.

A personal example from the Instructor and a contemporary video example.

Cognitive Exercise:

Questions for this exercise:

1) Look at the following questions from our first session and see how you answered them; tell us how you would answer them now:

A) Tell us what made you decide to join this group experience. Focus on the specific moments and events that made you decide it was time to seek support. (150 Words)

B) Tell us what you hope to get out of this experience. You goals are listed on your personal profile, so you can either expand upon them here, or discuss deeper motivations here. (150 Words)

C) Tell us a little bit about your military experience. Don't worry about going too deeply into the details, because we're going to have plenty of time to talk about everything. For now, just give us the highlights and broad strokes. (100 Words)

Psychoeducation:

Recap of neurobiology and how our brain is rewired by the pursuit of meaning.

Behavioral Exercise:

Video exercise where the Science Leader takes the Patient through the Escaping the Bog of War visualization exercise once more.

Questions for this exercise:

1) Now that you've completed your bog drawing, please upload a picture of it. Tell us what we're looking at in your own words. (100 Words)

2) Compare this bog to the one you drew in our second session. What's different now? What do you wish was different? (150 Words)

3) Tell us a few ways you might achieve some of those remaining goals. (150 Words)

Another Embodiment for Employing CarePod and/or IA

After the description of a potential psychotherapeutic and resiliency treatment plan given above, it will now be described several embodiments of employing the CarePod and/or IA to implement these and other treatment/diagnostic plans.

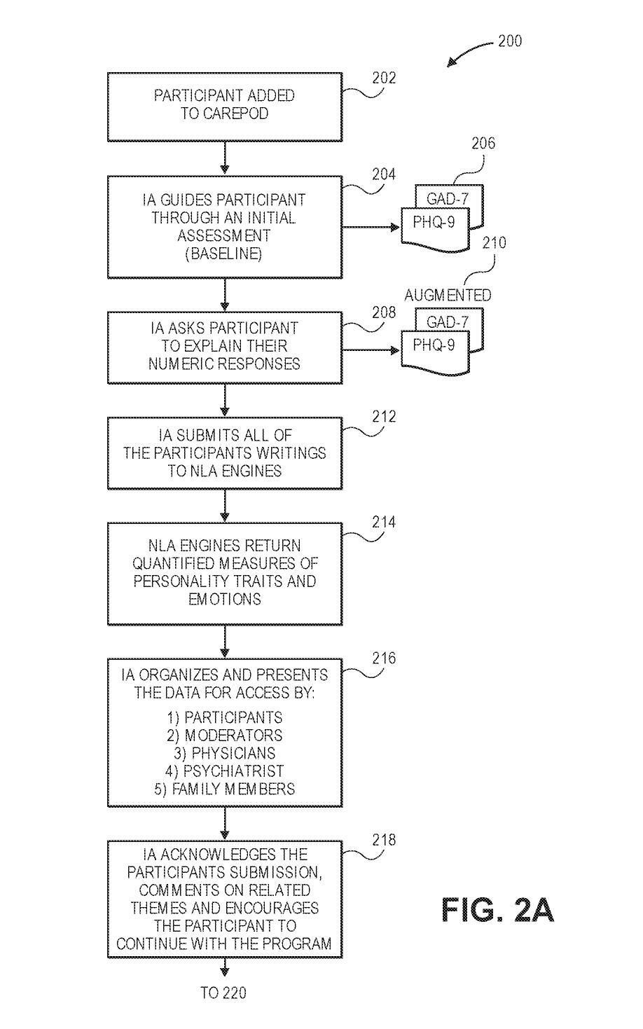

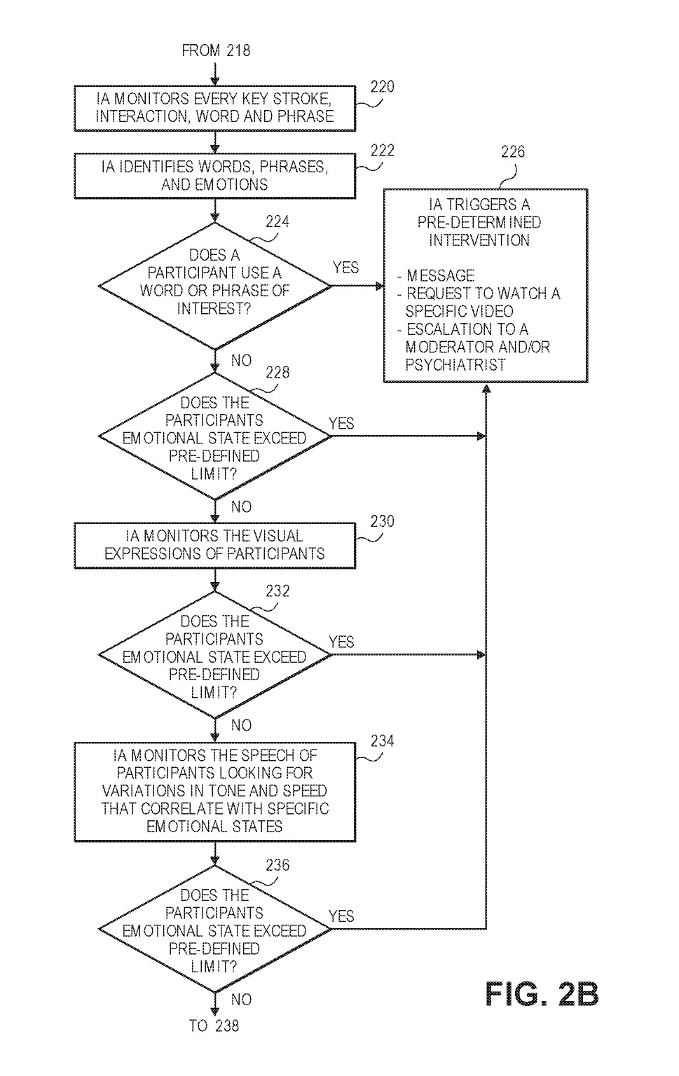

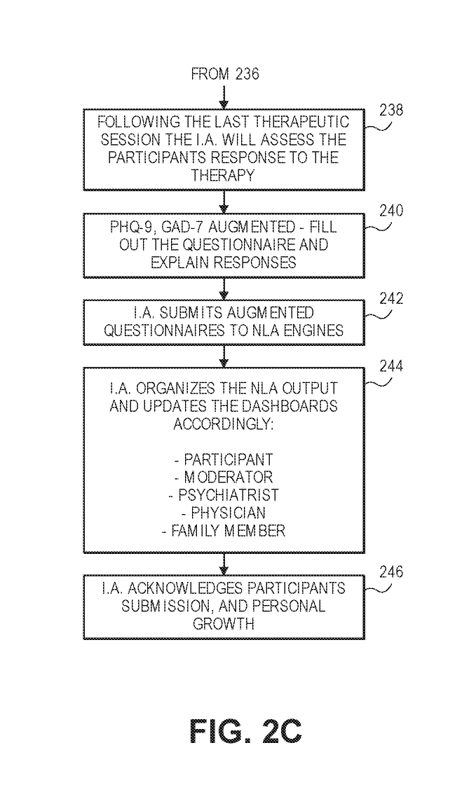

FIG. 2A (200) depicts how the CarePod may take in potential patients and CarePod members for psychotherapeutic diagnosis and/or treatment. Many embodiments of the present applications may employ all or just some of the following steps and are encompassed under the scope of the present application.

At 202, a participant/patient may be added to the CarePod. At 204, either the CarePod and/or the IA may guide the patient through an initial assessment (for a baseline of state). As may be seen, any number of psychotherapeutic protocols/tests may be administered at 206—e.g., GAD-7, PHQ-9 or the like.

At 208, CarePod/IA may take the participant/patient a process to explain their responses to the previous test. As mentioned above, CarePod/IA may affect changes on patient's smart device and send and receive data from patient via the patient's smart device. From the patient's explanations, CarePod/IA may—either autonomously or via some direction from a physician—augment the responses to the previous tests. Such augmentation may allow for better, targeted diagnosis and/or therapy.

At 212, CarePod/IA may submit all of the patient's responses and/or writings to the relevant databases/services—e.g., natural language, visual, aural analytics/databases, etc. In one embodiment, the analytics/databases may return certain measures of personality traits and emotions that have been gleaned from the ingest of patient data at 214.

At 216, the CarePod/IA may organize and present data for access by members of the CarePod—that is, those members who have been authenticated for access to potentially HIPAA-compliant information regarding the patient. Such members may include: patients, participants, moderators, physicians, psychiatrist and/or family member. Some data may have levels of access associated with it—that is, some members may have access and others not, depending on legal and medical standards of practice. At 218, CarePod/IA may acknowledge the participant/patient's submissions and comments on related themes. Encourage to continue therapy is also possibly given to the patient.

FIG. 2B continues the diagnostic and therapeutic program that may be followed by the CarePod/IA. At 220 and 222, CarePod/IA may monitor all manners of signal intelligence (e.g., keystrokes, utterances, gestures, etc.) given by the patient and may identify certain words, phrases and emotions—that may trigger certain actions (possibly alert and/or emergency actions), if deemed desirable. Such trigger data (generated from patient responses and other digital data captured by the patient's smart device), if and when detected by an IA (or other caregiver), may send an alert for either an automatic intervention (by the IA or other autonomous service of the CarePod) or send an alert to a human caregiver or emergency services.

For example, at 224, CarePod/IA may monitor for words/phrases of interest. If yes, then at 226, CarePod/IA may trigger a possible intervention, which could take the form of a range of actions/responses (depending on certain conditions). For example, CarePod/IA may give patient instructions to watch a video, engage in certain exercises (for calming, de-escalation, etc.), or elevate/escalate actions to a moderator and/or psychiatrist. In other more dire circumstances, CarePod/IA may call to dispatch emergency services.

At 228, CarePod/IA may assess (e.g., by testing some threshold conditions) as to whether the patient's emotional state has exceeded a limit that requires action. If so, CarePod/IA may act as at 226. At 234, CarePod/IA may monitor the patient's speech, looking for variation in tone and speed (as well as content) that correlate with specific emotional states. If so and if those states warrant action, CarePod/IA may act again as at 226. At 236, CarePod/IA continues to monitor for threshold emotional states and behaviors. If the threshold condition is met or exceeded, then CarePod/IA may automatically trigger intervention measures (e.g., to prevent the patient from causing harm to him/herself and to others). Such intervention measures may be to automatically guide (through an IA or CarePod) to reduce stress, anxiety or other conditions with visual and aural prompts meant to induce relief. The IA/CarePod may engage the patient in autonomous guided discussion to help the patient rationalize their stress, anxiety or other condition. If serious enough, the IA/CarePod may send near real-time communications alerts to human caregivers, other professionals, or call to dispatch 911 emergency services.

FIG. 2C again continues the diagnostic and therapeutic program that may be followed by the CarePod/IA. Over the course of this and/or other therapeutic sessions, CarePod/IA may assess the (ongoing) response to the therapy by the patient. From session to session, CarePod/IA may continue to augment earlier questionnaires, update dashboards of patient state and response and assess and give feedback to patient's progress in steps 238 through 246.

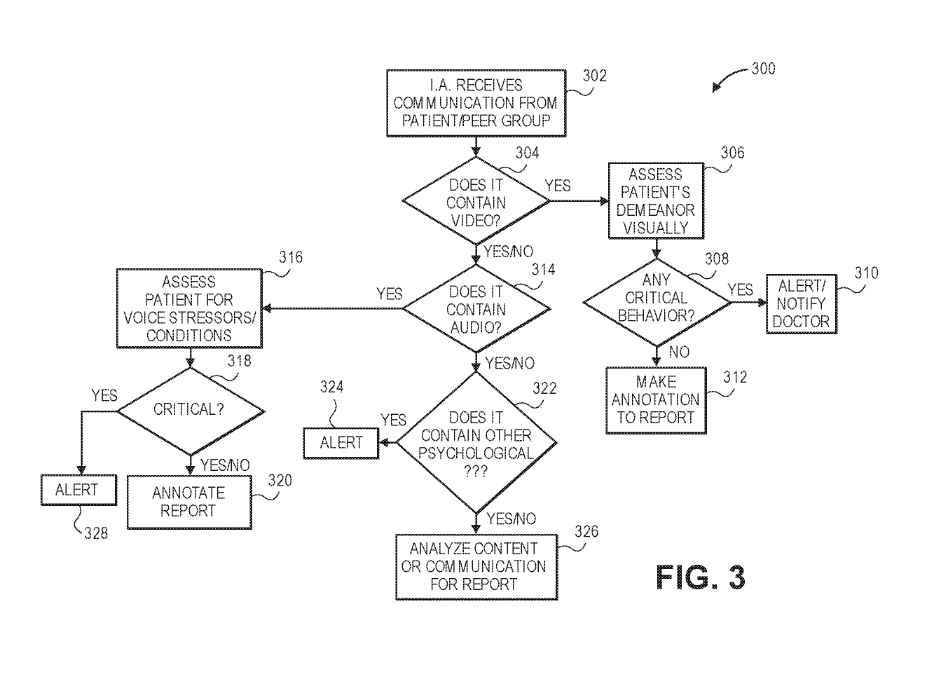

FIG. 3 shows a flowchart in which CarePod/IA may transition to monitoring and/or assessing patient's state and demeanor from ingesting further data (in whatever form it takes) at 302. For example, video data may be ingested and demeanor determined for critical behavior and make note or take alert action if deemed desirable at steps 304 through 312. A similar analysis may take place for audio data that may be assessed for stress and other states at steps 314 through 320/328. At 322, other psychological factors may be assessed (via ingested data) and either reported or alerted at 322 through 326.

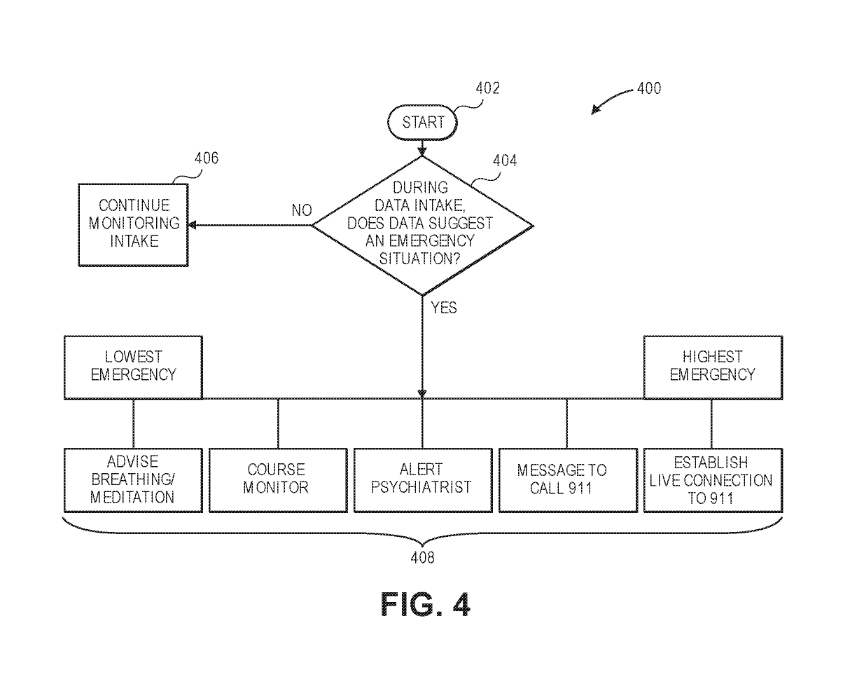

As mentioned above, not all noted concerning states and changes in states/status warrant the maximum response imaginable (e.g., calling police or emergency service). FIG. 4 depicts the range of possible response that CarePod/IA may (possibly autonomously) engage as a result of ingested data in steps 402 through 408. As shown, the lowest response may be to advice breathing/meditation exercises—and thereafter, start to escalate to continued monitoring, alerting a psychiatrist, messaging to 911—and/or establishing a live connection to 911 for the patient to receive real time care from emergency personnel.

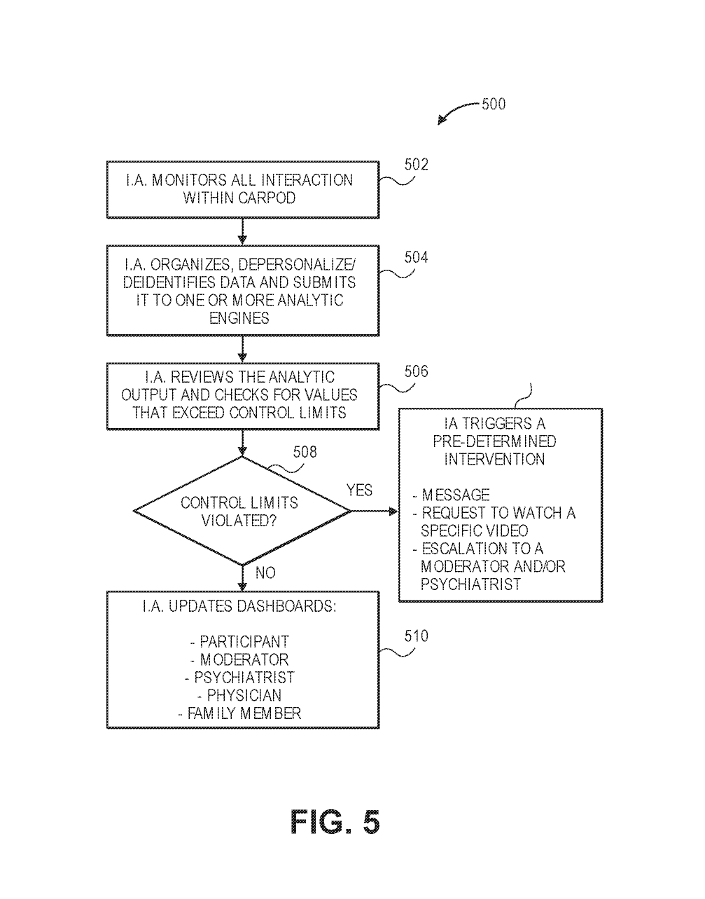

FIG. 5 depicts one embodiment of the CarePod/IA possible role in managing its interfacing with other databases/analytics over time—either in real time or asynchronously after one or more sessions. CarePod/IA monitors all of the member's interaction with CarePod/IA and may do several step with this ingested data. For example CarePod/IA may organize, de-identify and submit ingested data with databases/analytics (particularly, if these databases/analytics are not under HIPAA-compliance). CarePod/IA may receive and review analysis from such databases/analytics for behavior or states that exceed certain limits. As before, CarePod/IA may update patient dashboards and/or trigger certain interventions or actions in steps 502 through 512. Patient dashboards may be a part of the patient's CarePod database, or may be a data structure/storage that is resident in another part of the system.

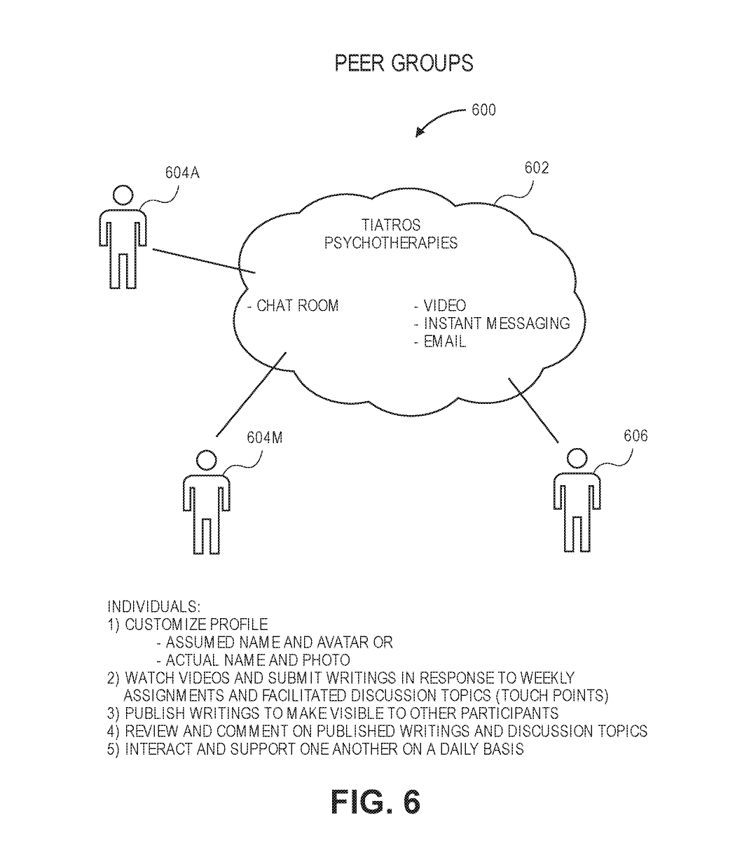

FIG. 6 depicts how a peer group (e.g., for supporting members in a session setting for a treatable condition) may interact with a CarePod/IA as described herein. As mentioned above, CarePod/IA may facilitate interactions between patients 604a, . . . , 604m and care provider 606 in a plurality of ways. For example, upon entering into a peer group, patients may be encouraged (or required) to customize their profile—with either actual name/photo or an assumed name/avatar. CarePod/IA may request/require that videos (and other instructional material) be watched and writings submitted in response. These writings may be shared with other participants—all the while the CarePod/IA is facilitating interaction and support for members for one another.

A detailed description of one or more embodiments of the invention, read along with accompanying figures, that illustrate the principles of the invention has now been given. It is to be appreciated that the invention is described in connection with such embodiments, but the invention is not limited to any embodiment. The scope of the invention is limited only by the claims and the invention encompasses numerous alternatives, modifications and equivalents. Numerous specific details have been set forth in this description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A computer-implemented method for integrating a patient wellness application into an electronic database platform, comprising:
instantiating a patient's data into a patient-specific, electronic database platform (CarePod), the CarePod configured to affect remote, electronic data transactions with the patient and the patient's caregivers associated with the patient's CarePod;
affecting remote data communications with the patient via a smart device that is configured to upload data to the CarePod and download commands and data from the CarePod;
through the remote data communications, guiding the patient through an assessment of patient health state by controlling the patient's smart device and downloading a set of tests to the patient, the test being at least one of a patient's mental health and patient's physiological health;
storing and analyzing the patient's response and recording data in a patient's dashboard;
depending on patient's response, guiding the patient to explain their responses and updating patient's dashboard in response;
storing and analyzing patient communications during the course of treatment, the communication analyzed according to one or more metrics determining patient health state; and
if a threshold condition is met, affecting at least one alert action in response to patient communications.

2. The computer-implemented method of claim 1 wherein the step of guiding the patient through an assessment of patient health state further comprises: instantiating an Intelligent Agent (IA) to communicate with the patient and the patient's CarePod through Application Programming Interfaces (API).

3. The computer-implemented method of claim 2 wherein the step of guiding the patient through an assessment of patient health state further comprises: establishing an initial baseline of health by administering a set of testing protocols and recording responses of the patient to the testing protocols.

4. The computer-implemented method of claim 3 wherein the step of storing and analyzing the patient's response and recording data in a patient's dashboard further comprises: recording the responses of the patient to the protocol and monitoring other digital data received by the patient's smart device during the administering of the testing protocol.

5. The computer-implemented method of claim 4 wherein the step of storing and analyzing the patient's response and recording data in a patient's dashboard further comprises: recording visual and aural data captured by the patient's smart device at the time of testing the patient.

6. The computer-implemented method of claim 4 wherein the step of storing and analyzing the patient's response and recording data in a patient's dashboard further comprises: correlating other digital data received by the patient's smart device with the responses of the patient to the testing protocol.

7. The computer-implemented method of claim 1 wherein the method further comprises: identifying trigger data captured by the patient's smart device by the IA and taking intervention action if the trigger data exceeds a threshold limit.

8. The computer-implemented method of claim 1 wherein the step of affecting at least one alert action in response to patient communications further comprises: taking one or a plurality of intervention steps to prevent the patient from causing harm.
